(19) United States
(12) Patent Application Publication
(10) Pub. No.: US 2019/0152086 A1
(43) Pub. Date: May 23, 2019

(54) Cutting Appliance

(71) Applicant: Hamilton Beach Brands, Inc., Glen Allen, VA (US)

(72) Inventor: Justin Dickerson, Goochland, VA (US)

(21) Appl. No.: 15/818,830

(22) Filed: Nov. 21, 2017

(51) Int. Cl. B26D 9/00; B26D 1/547; B26D 3/08; B26D 7/26; A23G 9/28

(52) U.S. Cl. CPC B26D 9/00; B26D 1/547; B26D 2210/02; B26D 7/2614; A23G 9/285; B26D 3/08

(57) ABSTRACT

A cutting appliance includes a selectively rotatable base to removably receive and secure a tub of material thereon. A scoring assembly is removably mounted to the base and includes two spaced apart and substantially parallel blades. The scoring assembly is selectively engageable with an outer sleeve of the tub to score a band in the outer sleeve upon rotation of the tub. The scored band is removable from the remainder of the outer sleeve to expose a cutting area of the material. A cutting assembly is mounted to the base and comprises a cutting tool to selectively slice reciprocally and radially through the exposed cutting area of the material. An elevational position of the scoring assembly and the cutting assembly is selectively adjustable relative to the base.

### BACKGROUND OF THE DISCLOSURE

The present disclosure relates generally to a cutting appliance and, more particularly, to a cutting appliance for cutting off a layer of material from a tub of the material.

Preparation of ice cream cakes on a commercial scale can involve obtaining a tall tub, usually cylindrical, of hard ice cream encased in an outer cardboard sleeve and slicing horizontally through the hard ice cream inside the sleeve to obtain at least one disk or layer that forms the body or a layer thereof of the cake. Frosting and other toppings may then be applied to decorate the cake including between layers if there is more than one ice cream layer.

Conventionally, a manual tool is utilized to cut through the tub to obtain the ice cream or disk layer, which comprises a scoring blade and a cutting wire anchored to a catch arm. Operation of the tool first involves circumferentially scoring the cardboard sleeve via the scoring blade to create a cutting slot about the periphery of the tub, which defines an entry and exit point for the wire. The blade is fixed and the tub must be rotated to create the cutting slot. The catch arm then holds the tub in place, and the cutting wire is manually pulled laterally through the hard ice cream at the cutting slot. Pulling of the cutting wire through the ice cream can be exceedingly difficult as well as dangerous for the operator.

Improvements to the manual tool have included a cutting appliance having a spinning table top base for clamping and mounting the ice cream tub thereon. A cutting wire is placed against the tub on one side in a loose state. A motor rotates or spins the base to spin the tub and a user progressively tightens the cutting wire (via a handle). Tightening of the cutting wire effects lateral cutting through the tub. As the tub is rotating, the cutting operation is complete when the wire reaches the diameter of the tub.

One drawback associated with both the conventional and subsequent cutting appliances is that mere pulling of a cutting wire laterally through hard ice cream to effectuate cutting therethrough is exceedingly difficult and requires a great amount of force. Moreover, such exertion of force increases the risk of injury to the operator. Another drawback associated with both of the conventional and subsequent cutting appliances is that despite the scoring of the cardboard sleeve, pieces of the cardboard are often dragged by the cutting wire into the ice cream and lodged therein. The machines can be complex to setup and operate, among other drawbacks.

Therefore, a cutting appliance that addresses the aforementioned challenges of use as well as safety issues for the operator would be advantageous.

### BRIEF SUMMARY OF THE DISCLOSURE

One aspect of the present disclosure is directed to a cutting appliance for cutting off a layer of a material from a tub, which may be cylindrical, of the material encased in an outer sleeve. The cutting assembly comprises a selectively rotatable base to removably receive and secure the tub thereon. A scoring assembly is removably mounted to the base and comprises two spaced apart and substantially parallel blades. The scoring assembly is selectively engageable with the outer sleeve of the cylindrical tub to circumferentially score a band in the outer sleeve upon rotation of the cylindrical tub. The scored band is removable from the remainder of the outer sleeve to expose a cylindrical cutting area of the material. A cutting assembly is mounted to the base and comprises a powered cutting tool to selectively slice reciprocally and radially through the exposed cylindrical cutting area of the material. A vertical position of the scoring assembly and the cutting assembly is selectively adjustable relative to the base to cut successive layers of the material from the tub.

### BRIEF DESCRIPTION OF THE DRAWINGS

The foregoing summary, as well as the following detailed description of the disclosure, will be better understood when read in conjunction with the appended drawings. For the purpose of illustrating the disclosure, there is shown in the drawings an embodiment of a cutting appliance which is presently preferred. It should be understood, however, that the disclosure is not limited to the precise arrangements and instrumentalities shown. In the drawings:

FIG. 1 is a top, front and side perspective view of a cutting appliance, in accordance with a preferred embodiment of the present disclosure;

FIG. 2 is a cross-sectional elevational view of the base of the cutting appliance of FIG. 1, taken along sectional line 2-2 of FIG. 1;

FIG. 3A is a rear and side exploded view of a scoring assembly of the cutting appliance of FIG. 1;

FIG. 3B is a front and side exploded view of a blade holder of the scoring assembly of FIG. 3A;

FIG. 4 is a cross-sectional elevational view of the scoring assembly of FIG. 3A, taken along sectional line 4-4 of FIG. 3A;

FIG. 5 is a partial side perspective view of the cutting appliance of FIG. 1, with the scoring assembly disconnected from a cantilever arm of the cutting appliance, and portions of the cantilever arm being removed to show interior components thereof;

FIG. 6A is a partial front and side perspective view of the scoring and cutting assemblies of the cutting appliance of FIG. 1, with an actuation lever in an unactuated position and the scoring blades in a normally retracted position, with portions of the cantilever arm being removed to show interior components thereof; and

FIG. 6B is a partial front and side perspective view of the scoring and cutting assemblies of the cutting appliance of FIG. 1, with an actuation lever in an actuated position and the scoring blades in an advanced position.

### DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the cutting appliance, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

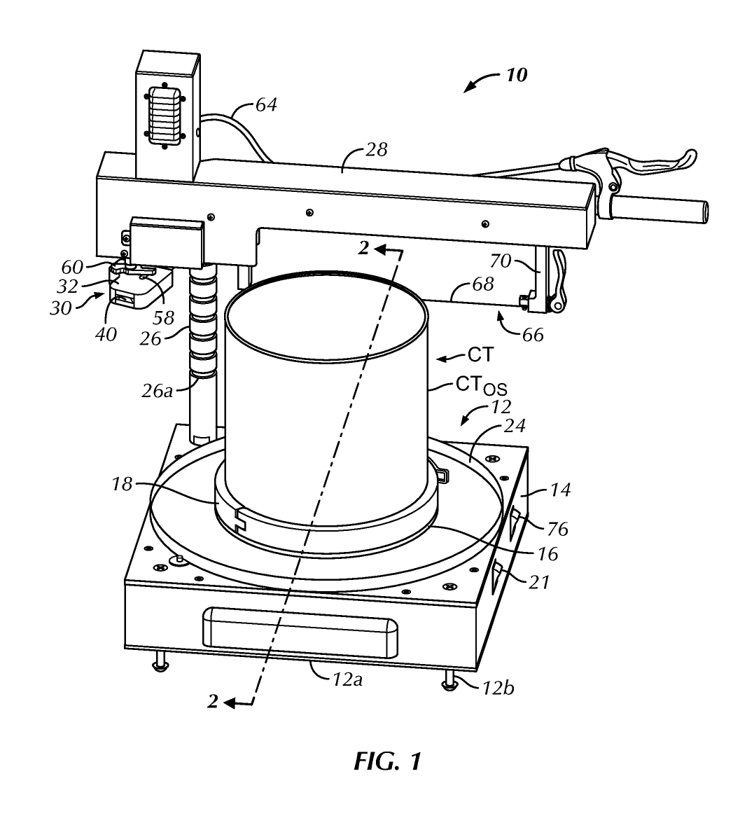

Referring to the drawings in detail, wherein like numerals indicate like elements throughout, there is shown in FIGS. 1-6B a cutting appliance, generally designated 10, in accordance with an embodiment of the present disclosure, for cutting off a disk or cylindrical layer of a material from a cylindrical tub CT of the material encased in an outer sleeve CT_{OS}. The material may be, for example, foodstuff in solid form, such as ice cream, but the disclosure is not so limited. The outer sleeve CT_{OS} may be, for example, a cardboard sleeve, but the disclosure is also not so limited. Examples provided herein are for a cylindrical tub, although other geometries would fall within the scope of the claims, as would be understood by one of ordinary skill in the art.

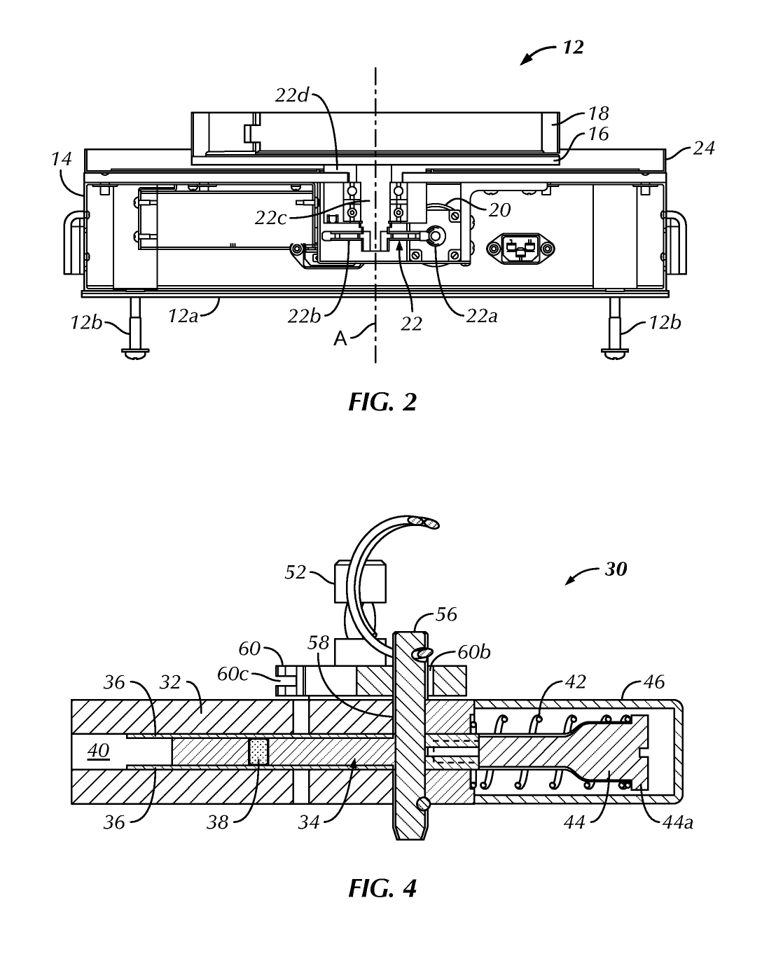

Turning to FIG. 2, the cutting appliance 10 includes a selectively, i.e., user activated, rotatable base 12 to removably receive and secure the cylindrical tub CT thereon. The base 12 comprises a housing 14 enclosing operative components of the base 12 therein (as will be described in further detail below), a turntable plate 16 removably mounted upon the housing 14 for receiving the cylindrical tub CT and an adjustable clamp 18, well understood by those of ordinary skill in the art, upon the plate 16 for selectively securing the cylindrical tub CT to the plate 16. The plate 16 is selectively rotatable about a central axis A thereof.

As shown best in FIG. 2, the plate 16 is rotatable via a motor 20 and a gearbox 22. In one embodiment, the motor 20 is a 24 volt DC motor, but the disclosure is not so limited. The motor 20 is powered in a manner well understood by those of ordinary skill in the art. A switch 21 is operatively connected between the motor 20 and the power source, also in a manner well understood by those of ordinary skill in the art, to selectively power the motor 20 on or off to rotate the plate 16. In one embodiment, the gearbox 22 comprises a worm screw 22a extending from the rotatable shaft of the motor 20 and meshed with a worm gear 22b. A shaft 22c extends between the worm gear 22b and a hub 22d rotationally fixed to an underside of the plate 16. The shaft 22c is rotatably fixed to the worm gear 22b and the hub 22d at opposing ends thereof in a manner well understood by those of ordinary skilled in the art, such as, for example, without limitation, via a removable key fit or spline, a friction/interference fit, or the like. As should be understood by those of ordinary skill in the art, the gearbox 22 may also take other forms, such as, for example, without limitation, a bevel gear drive. Alternatively, the motor 20 may be coaxially aligned with the hub 22d and the screw 22a extending from the motor 20 may directly engage the hub 22d.

To secure the cutting appliance 10, the base 12 may be fastened to an underlying support surface (not shown), e.g., a countertop, in a manner well understood by those of ordinary skill in the art. For example, the housing 14 may be bolted to an underlying support surface via fastening bolts 12b (FIGS. 1, 2), but the disclosure is not so limited. In one embodiment, an underside of the housing 14 may comprise a rubber base seal layer 12a to seal the appliance 10 against the underlying support surface and provide an anti-slip engagement therebetween. Optionally, as shown in FIG. 1, the plate 16 may be placed within a catch pan 24 (on top of the housing 14) to collect debris or foodstuff that falls from the tub CT to reduce clean-up.

As shown best in FIG. 1, the cutting appliance 10 further comprises a vertical post 26 extending from the base 12 and a cantilever arm 28 pivotably mounted to, and laterally extending from, the vertical post 26. A scoring assembly 30 is removably mounted to the cantilever arm 28. As will be explained in further detail below, the scoring assembly 30 is selectively engageable with the outer sleeve CT_{OS} of the cylindrical tub CT to circumferentially score a band in the outer sleeve CT_{OS} upon rotation of the cylindrical tub CT by the plate 16 of the base 12. The scored band is thereafter removable from the remainder of the outer sleeve CT_{OS} to expose a cylindrical cutting area (not shown) of the material.

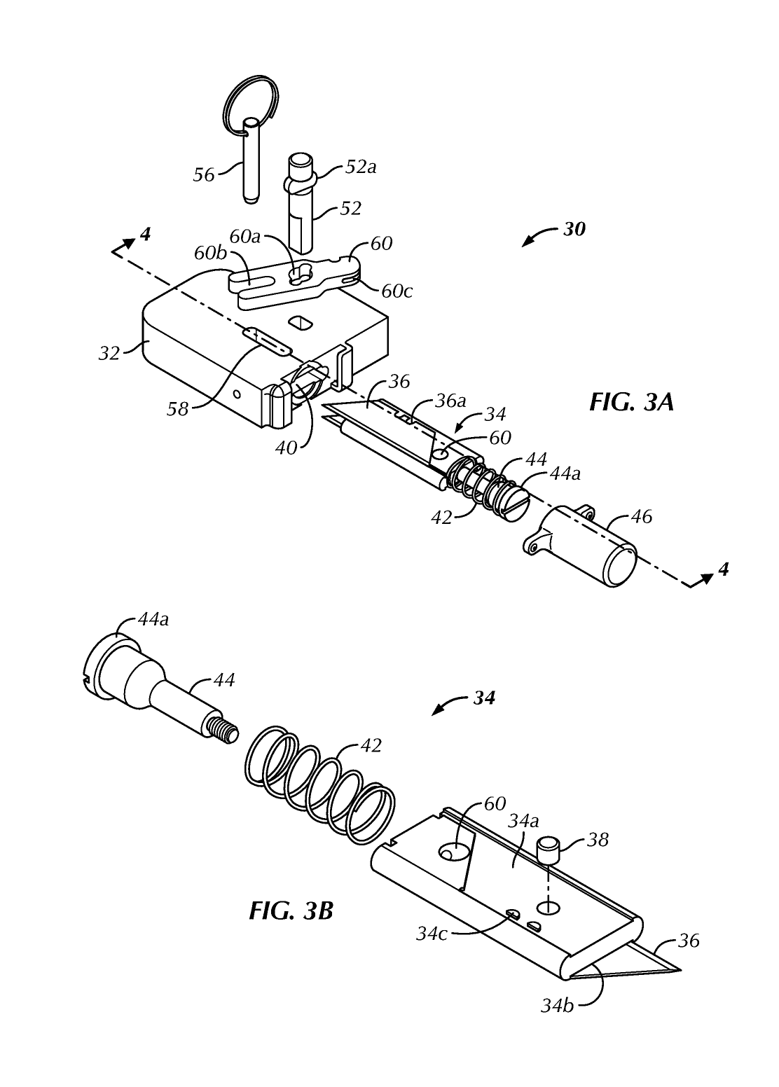

As shown best in FIGS. 3A, 3B, the scoring assembly 30 comprises a blade bracket 32. which supports and retains the components for blade actuation, as will be explained. The blade bracket 32 removably houses a blade holder 34 slidably received therein. Turning to FIG. 3B, the blade holder 34 has a first pocket 34a at an upper side thereof to removably receive a first of two blades 36 therein (e.g., conventional box cutter blades) and a second pocket 34b at bottom side of the blade holder 34 to removably receive a second of the two blades 36 therein. The two spaced apart blades 36 are oriented substantially parallel to one another. As should be understood by those of ordinary skill in the art, the first and second pockets 34a, 34b substantially match the profile of the respective blades 36 received therein. A magnet 38 is positioned within the blade holder 34 to attract and secure the blades 36 within the respective first and second pockets 34a, 34b and prevent the blades 36 from falling out unexpectedly. As shown, the pockets 34a, 34b also each include at least one rib 34c (two ribs 34c shown in FIG. 3B) sized, shaped and positioned to complementarily fit within a corresponding groove 36a of a respective blade 36, to ensure proper alignment of the blades 36 within the pockets 34a, 34b and to prevent the blades 36 from sliding within the pockets 34a, 34b.

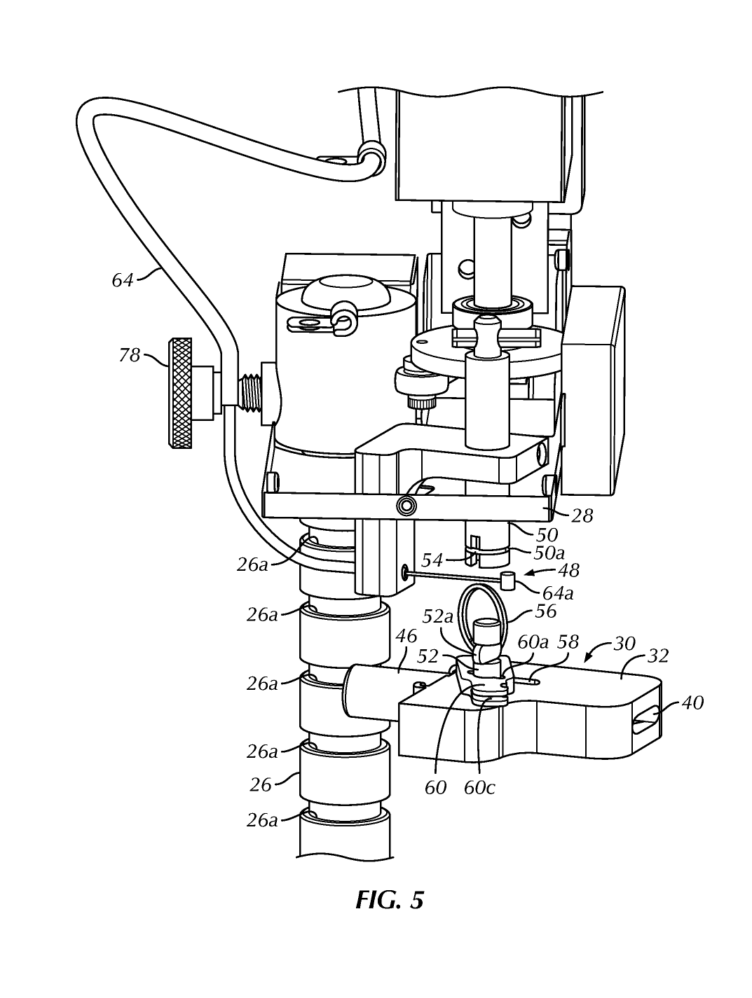

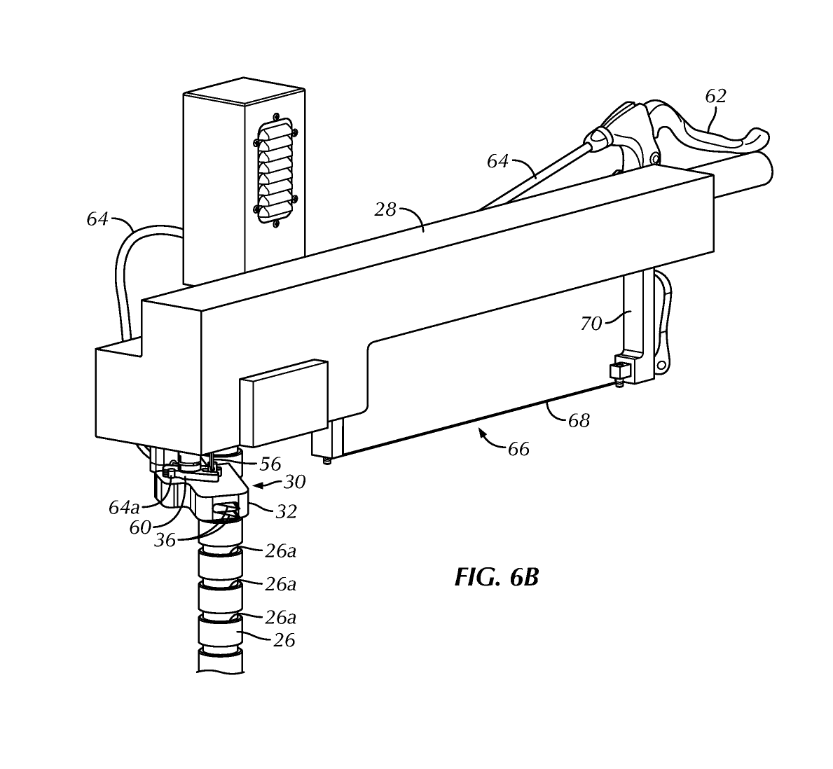

Turning to FIGS. 3A and 4, the blade holder 34 is slidably received within a cavity 40 of the blade bracket 32, which further traps the blades 36 in place in the pockets 34a, 34b. The scoring assembly 30 further comprises a biasing member 42 exerting a retractive biasing force on the blade holder 34 to maintain the blades 36 in a normally retracted position (FIGS. 4, 6A), wherein a cutting edge of each of the blades 36 is shielded within the cavity 40 of the blade bracket 32. In the illustrated embodiment, the biasing member 42 takes the form of a compression spring. A screw 44 is threaded into a rear end of the blade holder 32 and the compression spring 42 is compressed between a rear end of the blade bracket 32 and the head 44a of the screw 44, thereby biasing the blade bracket 32 and the compressions spring 42 apart, and, in turn, maintaining the blade holder 32 (attached to the spring 42) in the retracted position. A screw cover 46 is attached to the rear end of blade bracket 32 and houses the screw 44 therein. Cover 46 serves to keep debris out of the area around spring 42. As should be understood by those of ordinary skill in the art, however, the biasing member 42 may take the form of any member capable of storing and releasing a biasing force. Non-limiting examples include other springs (e.g., torsion or leaf springs), elastic bands, and the like.

A removable detent pin 56 extends through an elongate slot 58 of the blade bracket 32 and an aperture 60 (generally complementary in shape to the pin 56) in the blade holder 34 to removably secure the blade holder 34 within the cavity 40 of the blade bracket 32 (FIGS. 1, 3A and 5). The removable pin 56 is selectively laterally slidable along the elongate slot 58, while engaged with the blade holder 34, to slide the blade holder 34 forward to advance and expose the cutting edges of the blades 36 as well as backward to retract the blades 36. Pin 56 in slot 58 defines the stroke distance the blades can move laterally. As will be explained further below, the biasing force of the compression spring 42, which keeps the blade holder 34 retracted, may be selectively overcome by a user to advance the blade holder 34 and expose the respective cutting edges of the blades 36 to score the outer sleeve CT_{OS} of the cylindrical tub CT.

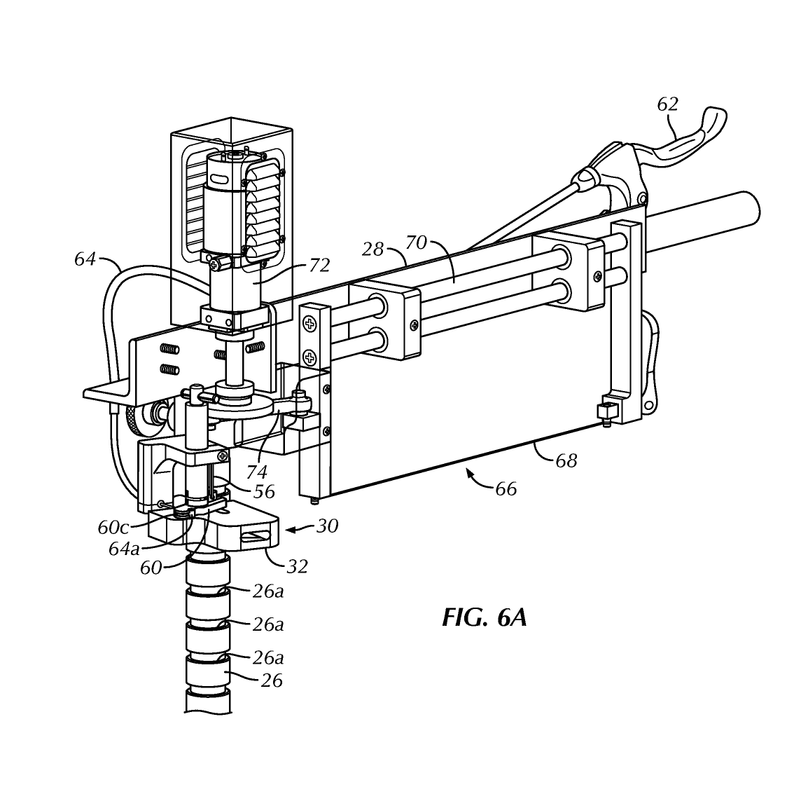

As shown in FIG. 5, the scoring assembly 30 is removably mounted to the cantilever arm 28 via a quick connect and disconnect fitting 48. In the illustrated embodiment, the fitting 48 comprises a first shaft 50 extending from the cantilever arm 28 and a second shaft 52 attached to, and extending from, the blade bracket 32 (e.g., via a friction/interference fit). The second shaft 52, having a flanged portion 52a, is receivable within a hollow of the first shaft 50 and an external retaining ring 54 is mounted in a peripheral groove 50a of the first shaft 50, acting a shoulder for the flanged portion 52a to retain the second shaft 52 within the first shaft 50. As should be understood by those of ordinary skill in the art, the retaining ring 54 is expandable by the flanged portion 52a with a withdrawal force of the second shaft 52, such that a user may quickly detach/disconnect the scoring assembly 30 from the cantilever arm 28. A user may detach the scoring assembly 30 to clean the assembly and/or to replace the blades 36, for example. Conversely, the retaining ring 54 is expandable by the flanged portion 52a with an insertion force of the second shaft 52 into the hollow of the first shaft 50 to attach the scoring assembly 30 to the cantilever arm 28. As should be understood, however, the quick connect and disconnect fitting 48 may take the form of other fittings capable of providing a similar function. One non-limiting example of an alternative quick connect and disconnect fitting 48 is a detent connection.

As shown best in FIG. 3A, the scoring assembly 30 further comprises an actuation fork 60 pivotably mounted upon the blade bracket 32. As shown, the actuation fork 60 includes an aperture 60a through which the second shaft 52 projects, the second shaft 52 defining the pivot axis of the actuation fork 60. The actuation fork 60 also includes a generally U-shaped opening 60b at one end thereof, removably and slidably engaged by the removable pin 56, whereby pivoting of the actuation fork 60 by a user slides the removable pin 56 along the elongate slot 58. At the opposing end, the actuation fork 60 includes a laterally open slot 60c.

As shown in FIGS. 6A and 6B, the cutting appliance 10 further comprises a lever 62 operatively engageable with the scoring assembly 30 and actuatable by a user to overcome the biasing force of the biasing member 42 and expose the respective cutting edges of the blades 36. As shown, the lever 62 is coupled with the actuation fork 60 via a cable 64. In the illustrated embodiment, the lever 62 is positioned at the free end of the cantilever arm 28, but the disclosure is not so limited. The cable 64, e.g., a Bowden cable, extends between the lever 62 and the actuation fork 60. As shown best in FIG. 5, the cable 64 includes a flanged end 64a, e.g., a lug or collar, to engage the shoulder created by the laterally open slot 60c of the actuation fork 60 at the other end.

As shown in FIG. 6A, the lever 62 is normally in an unactuated/uncompressed state, and, accordingly, the cable 64 is in a relaxed state. In the illustrated embodiment, the lever 62 is a hand brake handle, but the disclosure is not so limited. In the relaxed state, the cable 64 applies a mechanical force on the actuation fork 60 less than the biasing force of the biasing member 42 on the blade holder 34. In the unactuated state of the lever 62, the cable 64 may apply substantially no mechanical force on the actuation fork 60 at all. Accordingly, the blade holder 34 remains in the retracted state thereof. As should be understood by those of ordinary skill in the art, actuation, e.g., compression, of the lever 62 (FIG. 6B) generates tension on the cable 64, and, in turn, transmits a pulling force via the flanged end 64a on the laterally open slot 60c of the actuation fork 60. The pulling force generated on the actuation fork 60 is greater than, and in an opposite direction to, the biasing force of the biasing member 42. Accordingly, the actuation fork 60 is pivoted about the second shaft 52 by the pulling force of the cable 64, to, in turn, slide the removable pin 56 (which is engaged with the U-shaped opening 60b at the opposing end of the actuation fork 60) forward along the elongate slot 58, overcoming the biasing force of the biasing member 42, and advance the blade holder 34 forward and to expose the cutting edges of the blades 36. Release of the lever 62 permits the biasing member 42 to retract the blade holder 34 back to the normally retracted position thereof, and, in turn, withdraw the blades 36.

Turning to FIGS. 1, 6A and 6B, the cutting appliance 10 further comprises a cutting assembly 66 mounted to the base 12 and comprising a cutting tool 68 to selectively slice reciprocally and radially through the cylindrical tub CT. As shown, the cutting assembly 66 is also secured to the cantilever arm 28. In the illustrated embodiment, the cutting assembly 66 comprises a linear slide 70 (understood by those of ordinary skill in the art) movable in a reciprocating motion, and the cutting tool 68 takes the form of a cutting wire tensioned between, and removably secured to, opposing ends of the linear slide 70. The cutting wire 68 is elevationally positioned to be at an elevation between the two blades 36 of the scoring assembly 30. In one non-limiting example, the cutting wire 68 is tensioned by using a conventional cam clamp, thus making the wire 68 easily removable and replaceable.

The cutting assembly 66 further comprises a motor 72 coupled to the linear slide 70. One non-limiting example of the motor 72 is a 24 volt DC motor. An eccentric linkage 74 connects the motor 72 with the linear slide 70 to translate the rotational motion of the motor 72 to a reciprocal cutting motion for the linear slide 70 and the tensioned cutting wire 68 in a manner well understood by those of ordinary skill in the art. A switch 76 (FIG. 1) is operatively connected between the motor 74 and a power source (not shown), in a manner well understood by those of ordinary skill in the art, to selectively power the motor 74 on or off to activate the cutting assembly 66.

As explained above, both the scoring assembly 30 and the cutting assembly 66 are attached to the cantilever arm 28. The height of the cantilever arm 28 is selectively adjustable via the connection between the arm 28 and the vertical post 26, thereby selectively adjusting the elevational position of the scoring assembly 30 and the cutting assembly 66 relative to the base 12 supporting the cylindrical tub CT. As shown best in FIG. 5, the vertical post 26 includes a plurality of peripheral, i.e., circumferential, grooves 26a and the cantilever arm 28 is mounted to the vertical post 26 via a selectively retractable spring plunger 78 engageable with, and selectively, temporarily disengageable from, a groove 26a in a manner well understood by those of ordinary skill in the art. The engagement of the spring plunger 78 with a groove 26a permits the cantilever arm 28 to pivot about the vertical post 26, while setting and maintaining the elevational height thereof. In one embodiment, the grooves 26a are each spaced approximately 1″ apart, such that the elevational setting of the cantilever arm 28 is adjustable in 1″ increments, but the disclosure is not so limited. As should be understood, the grooves 26a may be spaced apart differently.

In use, a user places the cylindrical tub CT of material on the turntable plate 16 and secures the tub CT via the clamp 18. The user then pivot the cantilever arm 28 toward the tub CT and adjusts the height of the arm 26 along the vertical post 26 (via the retractable spring plunger 78) accordingly to the height of the tub CT and the desired thickness of the slice of material. The user then powers on the motor 20 (via the switch 21) to start rotating the plate 16 (and the tub CT) about the central axis A thereof. The user then compresses the handle 62 to advance the cutting edges of the blades 36 outwardly and outside of the blade bracket 32 (as explained previously) (FIG. 6B) and pivots the cantilever arm 28 to engage the blades 36 of the scoring assembly 30 with the rotating tub CT. After at least one full revolution of the cylindrical tub CT, a cylindrical band of the outer sleeve CT_{OS} (having a thickness equivalent to the distance between the two blades 36) is scored by the two substantially parallel blades 36 of the scoring assembly 30. The user then releases the handle 62, such that the blades 36 are retracted back to their normal position (as explained previously) (FIG. 6A), powers off the motor 20 to cease rotation of the tub CT and removes the scored band of the outer sleeve CT_{OS}, e.g., with a scissor, from the remainder of the outer sleeve CT_{OS} to expose a cylindrical cutting area of the material, which is about as thick as the distance between the two blade 36.

Thereafter, the motor 20 is powered back on to start rotating the tub CT once more and the motor 72 is also powered on (via the switch 76) to initiate the reciprocating motion of the linear slide 70 and the tensioned cutting wire 68 (as explained previously). The user then pivots the cantilever arm 28 to engage the cutting wire 68 with the exposed cylindrical cutting area of the material, i.e., the area of the material having the scored band of the outer sleeve CT_{OS} removed, to slice reciprocally and radially through the exposed cylindrical cutting area of the material and obtain a layer of the material. To perform another cut, the user re-adjusts the elevational lever of the cantilever arm 28 and repeats the same steps. Power can be discontinued to both motors after each successive cut and before adjusting the elevational lever. Removal of a band of the outer sleeve CT_{OS} about the portion of the material where it will be cut advantageously ensures that no pieces of the outer sleeve CT_{OS} are dragged by the cutting wire 68 into the material. Moreover, reciprocation of the cutting wire 68 along with the radial passing thereof through the material produces more effective cutting, requiring less force by the user.

As should be understood, a user may also desire to detach the scoring assembly 30 from the cutting appliance 10, for example, to clean the scoring assembly 30 or to replace the blades 36. Accordingly, the user merely pulls down on the scoring assembly 30 to detach from the cantilever arm 28 via the quick connect and disconnect fitting 48 (as explained previously) (FIG. 5). Thereafter the user may remove the removable detent pin 56. The blade holder 34 is thereafter removable from the blade bracket 32. The blades 36 are thereafter free to be replaced and the scoring assembly 30 may be cleaned. The user may then perform the reverse steps to reinsert the blade holder 34 into the cavity 40 of the blade bracket 32, reinsert the detent pin 56 and reattach the scoring assembly 30 to the cantilever arm 28. As previously explained, the turntable plate 16 is also removable from the housing 14 of the base 12 by pulling the plate 16 upward, e.g., for cleaning and/or replacement.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A cutting appliance for cutting off a layer of a material from a tub of the material encased in an outer sleeve, the cutting assembly comprising:
a selectively rotatable base to removably receive and secure the tub thereon;
a scoring assembly removably mounted to the base and comprising two spaced apart and substantially parallel blades, the scoring assembly being selectively engageable with the outer sleeve of the tub to score a band in the outer sleeve upon rotation of the tub, the scored band being removable from the remainder of the outer sleeve to expose a cutting area of the material; and
a cutting assembly mounted to the base and comprising a cutting tool to selectively slice reciprocally through the exposed cutting area of the material;
an elevational position of the scoring assembly and the cutting assembly being selectively adjustable relative to the base.

2. The cutting appliance of claim 1, wherein the scoring assembly comprises a blade bracket having a blade holder removably and slidably received within the blade bracket, the blade holder having a first pocket at an upper side thereof to removably receive a first of the two blades therein and a second pocket at bottom side of the blade holder to removably receive a second of the two blades therein

3. The cutting appliance of claim 2, wherein the blade holder further comprises a magnet therein to removably secure the blades in the respective pockets.

4. The cutting appliance of claim 2, wherein the scoring assembly further comprises a biasing member exerting a retractive biasing force on the blade holder to maintain the blades in a retracted position, wherein a cutting edge of each of the blades is shielded within the blade bracket, the biasing force being selectively overcome by a user to expose the respective cutting edges of the blades to score the outer sleeve of the tub.

5. The cutting appliance of claim 4, further comprising a lever operatively engageable with the scoring assembly and actuatable by a user to overcome the biasing force and expose the respective cutting edges of the blades.

6. The cutting appliance of claim 4, wherein the scoring assembly further comprises a removable pin extending through the blade bracket and the blade holder to removably secure the blade holder within the blade bracket, the blade bracket including a lateral slot therein along which the removable pin is selectively laterally slidable, against the biasing force of the biasing member, to advance and expose the cutting edges of the blades.

7. The cutting appliance of claim 6, wherein the scoring assembly further comprises an actuation fork pivotably mounted upon the blade bracket, the actuation fork being engaged with the removable pin, whereby pivoting of the actuation fork by a user slides the removable pin along the lateral slot.

8. The cutting appliance of claim 7, further comprising a lever coupled with the actuation fork via a cable, whereby actuation of the lever pivots the actuation fork, to, in turn, slide the removable pin through the lateral slot against the force of the biasing member and advance and expose the cutting edges of the blades.

9. The cutting appliance of claim 8, wherein the lever is a hand brake handle.

10. The cutting appliance of claim 1, further comprising a vertical post extending from the base and a cantilever arm pivotably mounted to, and laterally extending from, the vertical post, the scoring assembly and the cutting assembly being mounted to the cantilever arm, a height of the cantilever arm being selectively adjustable along the vertical post to adjust the elevational position of the scoring assembly and the cutting assembly.

11. The cutting appliance of claim 10, wherein the cantilever arm is mounted to the vertical post via a retractable spring plunger for adjusting the height of the cantilever arm along the vertical post.

12. The cutting appliance of claim 10, wherein the scoring assembly is mounted to the cantilever arm via a quick connect and disconnect fitting.

13. The cutting appliance of claim 12, wherein the quick connect and disconnect fitting is a spring clip.

14. The cutting appliance of claim 1, wherein the cutting tool comprises a tensioned wire.

15. The cutting appliance of claim 14, wherein the cutting assembly further comprises a linear slide movable in a reciprocating motion, and wherein the tensioned wire is removably secured at opposing ends thereof to the linear slide.

16. The cutting appliance of claim 15, wherein the cutting assembly further comprises a motor coupled to the linear slide via an eccentric linkage.

17. The cutting appliance of claim 1, further comprising a motor to rotate the base.
